(19) United States
(12) Patent Application Publication
(10) Pub. No.: US 2006/0193232 A1
(43) Pub. Date: Aug. 31, 2006

(54) Miniature guided wavelength multiplexed holographic storage system

(76) Inventors: Steve Redfield, Falls Church, VA (US); Kismine Starr, Santa Fe, NM (US); Tim Harvey, Fairfax, VA (US); Don Schmadel, College Park, MD (US)

Correspondence Address: HOWISON & ARNOTT, L.L.P, P.O. BOX 741715, DALLAS, TX, 75374-1715, US

(21) Appl. No.: 11/251,576

(22) Filed: Oct. 14, 2005

Related U.S. Application Data
(60) Provisional application No. 60/618,921, filed on Oct. 14, 2004.
(60) Provisional application No. 60/618,917, filed on Oct. 14, 2004.
(60) Provisional application No. 60/618,916, filed on Oct. 14, 2004.

(51) Int. Cl. G11B 7/00

(52) U.S. Cl. 369/103

(57) ABSTRACT

A holographic data storage system is disclosed. The data storage system includes a holographic data storage media adapted to receive a data beam and a reference beam and store a data pattern associated with the data beam. The stored data pattern is expressed by a holographic representation corresponding to data elements of the data beam.

### CROSS REFERENCE TO RELATED APPLICATIONS

This application claims the benefit of: U.S. Provisional Application No. 60/618,921, filed Oct. 14, 2004, titled “USES OF WAVE GUIDED MINIATURE HOLOGRAPHIC SYSTEM,” U.S. Provisional Application No. 60/618,917, filed Oct. 14, 2004, titled “MINIATURE GUIDED WAVELENGTH MULTIPLEXED HOLOGRAPHIC STORAGE SYSTEM,” and U.S. Provisional Application No. 60/618,916, filed Oct. 14, 2004, titled “BRANCH PHOTOCYCLE TECHNIQUE FOR HOLOGRAPHIC RECORDING IN BACTERIORHODOPSIN,” which are hereby incorporated by reference. This application is related to, and is being filed concurrently with, U.S. patent application Ser. No. ______, titled “BRANCH PHOTOCYCLE TECHNIQUE FOR HOLOGRAPHIC RECORDING IN BACTERIORHODOPSIN,” to be assigned to Starzent, Inc. of Fairfax Virginia and U.S. Patent Application No. ______, titled “USES OF WAVE GUIDED MINIATURE HOLOGRAPHIC SYSTEM,” to be assigned to Starzent, Inc. of Fairfax Virginia, which are hereby incorporated by reference.

### TECHNICAL FIELD OF THE INVENTION

This invention is related to data storage medium in general, and, more particularly, to holographic data storage media.

### BACKGROUND OF THE INVENTION

Traditional storage media such as magnetic media are typically two-dimensional (2D) in scope. Holographic storage media is a three-dimensional (3D) recording technology and therefore offers greater storage densities than traditional 2D media. Typically, holographic media recording and information systems use angle encoding to multiplex different recorded data images or pages. This requires beam deflection, which then requires a non trivial standoff distance from the beam source. The resulting systems may have large form factors. Moreover the beam deflection typically requires moving that may be prone to failure, such as galvanometers.

What is needed is a system and method that addresses the above, and related, issues.

### SUMMARY OF THE INVENTION

The present invention disclosed and claimed herein, in one aspect thereof, comprises a holographic data storage system. The data storage system includes a holographic data storage media adapted to receive a data beam and a reference beam and store a data pattern associated with the data beam. The stored data pattern is expressed by a holographic representation corresponding to data elements of the data beam.

### BRIEF DESCRIPTION OF THE DRAWINGS

For a more complete understanding of the present invention and the advantages thereof, reference is now made to the following description taken in conjunction with the accompanying drawings in which:

FIG. 1 is a schematic illustration of one embodiment of a holographic data storage system in accordance with principles of the present disclosure;

FIG. 2 is a schematic illustration of one embodiment of an optical switch structure for use in a holographic memory system;

FIG. 3 is a schematic illustration of another embodiment of an optical switch for use in a holographic memory system;

FIG. 4 is a schematic illustration of another embodiment of a holographic data storage system in accordance with principles of the present disclosure;

FIG. 5 is a schematic illustration of another embodiment of a holographic data storage system in accordance with principles of the present disclosure;

FIG. 6 is an illustration of side view of a portion of the holographic data storage system of FIG. 5;

FIG. 7 is a schematic illustration of another embodiment of a holographic data storage system in accordance with principles of the present disclosure;

FIG. 8 is a schematic illustration of another embodiment of a holographic data storage system in accordance with principles of the present disclosure;

FIG. 9 is a plan view of another embodiment of a holographic data storage system in accordance with principles of the present disclosure;

FIG. 10 is an illustration of a side view of a portion of a holographic data storage system in accordance with principles of the present disclosure;

FIG. 11 is an illustration of a side view of a portion of a holographic data storage system in accordance with principles of the present disclosure;

FIG. 12 is a schematic illustration of another embodiment of a holographic data storage system in accordance with principles of the present disclosure;

FIG. 13 is a schematic illustration of another embodiment of a holographic data storage system in accordance with principles of the present disclosure.

FIG. 14 is a schematic illustration of a combined spatial light modulator (SLM) and imager; and

FIG. 15 is a schematic illustration of a portion of a holographic data storage system utilizing a conjugate record and read geometry.

### DETAILED DESCRIPTION OF THE INVENTION

This application claims priority to U.S. Provisional Application No. 60/618,921, filed Oct. 14, 2004, titled “USES OF WAVE GUIDED MINIATURE HOLOGRAPHIC SYSTEM,” U.S. Provisional Application No. 60/618,917, filed Oct. 14, 2004, titled “MINIATURE GUIDED WAVELENGTH MULTIPLEXED HOLOGRAPHIC STORAGE SYSTEM,” and U.S. Provisional Application No. 60/618,916, filed Oct. 14, 2004, titled “BRANCH PHOTOCYCLE TECHNIQUE FOR HOLOGRAPHIC RECORDING IN BACTERIORHODOPSIN,” which are hereby incorporated by reference

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

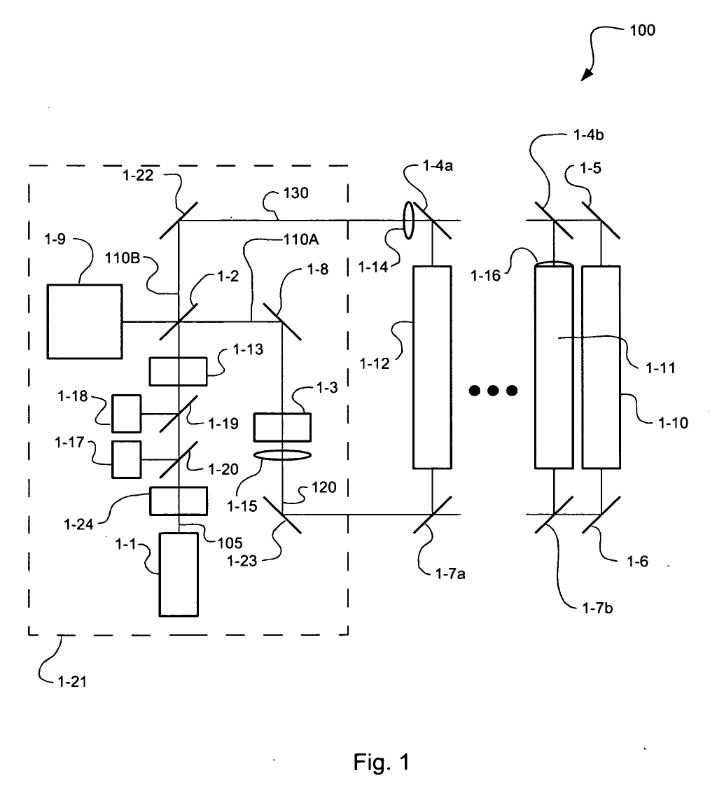

Referring now to FIG. 1, a schematic illustration of one embodiment of a holographic data storage system 100 in accordance with principles of the present disclosure is shown. As will be described, the present disclosure provides a method and system for storing and retrieving information, or data, without the use of mechanical devices like spinning disks or other moving parts. In the embodiment of FIG. 1, the record and read geometry used for storing and retrieval respectively, is termed forward image. During recording, a laser 1-1 directs laser light, or a laser beam 105 to a beamsplitter 1-2. The laser 1-1 may be an LD1240 manufactured by Power Technology, Inc. of Little Rock, Ark., or another suitable laser. A portion 110A of the beam proceeds to reflector 1-8 and from there to a spatial light modulator (SLM) 1-3, which could be, for example, a Cyberdisplay 300M manufactured by Kopin Corporation of Westborough, Mass. The SLM 1-3 impresses data onto the beam 110A by spatially modulating the amplitude using a polarizer placed after a liquid crystal device which rotates the polarization at various locations or pixels with each pixel corresponding to some aspect of the information or data being recorded.

The modulated beam, now referred to as the data beam 120, proceeds to reflector 1-23 and from there to reflector 1-6 or to one or more optional optical switches only two of which are shown as 1-7a, 1-7b. The optical switches 1-7a and 1-7b may be placed as shown to route the data beam 120 to storage locations 1-12 and 1-11 respectively. When only one storage location is present, reflector 1-6 directs beam 120 to storage location 1-10.

In the present embodiment, a storage location 1-10, 1-11, or 1-12 into which the data is recorded is in the form of a rod although additional forms are contemplated, including shapes with retangular cross-section. The capacity of the data storage system 100 can be increased by placing additional locations and optical switches between 1-12 and 1-11 as indicated by the ellipsis, expanding the assembly as necessary.

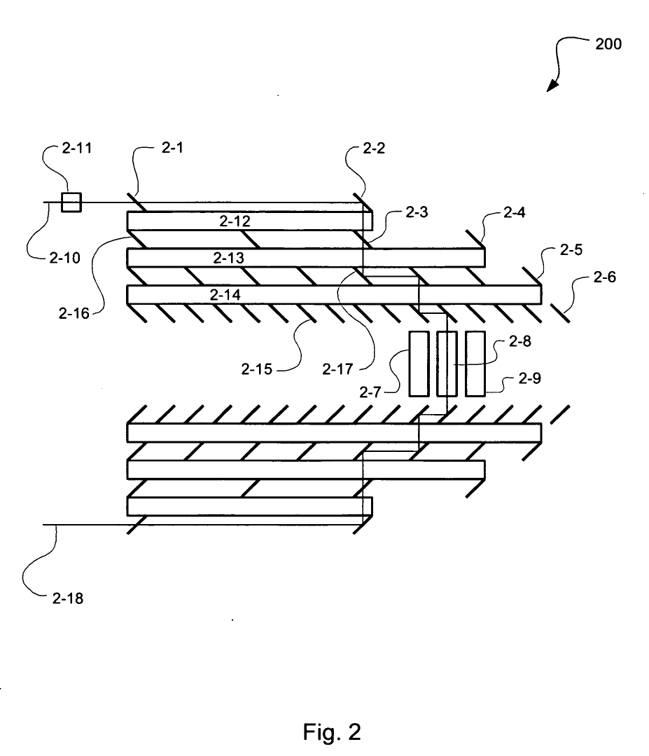

The other portion of the beam from beamsplitter 1-2, the reference beam 110B, proceeds to a reflector 1-22, and from there to reflector 1-5 or to one or more optional optical switches only two of which are shown as 1-4a, 1-4b. The optical switches 1-4a and 1-4b may be placed as shown to route the reference beam 110B to storage locations 1-12 and 1-11 respectively. When only one storage location is present, reflector 1-6 directs beam 10B to storage location 1-10. In one embodiment, the optical switches 1-4a, 1-4b, 1-7a, and 1-7b are liquid crystal devices coupled with polarizing beamsplitters and are described in greater detail below in reference to FIG. 2. The data beam 120 and the reference beam 10B, having entered a particular storage location, interfere with the resulting electromagnetic field reacting with the medium to form a hologram, thus storing information.

During a data read cycle, the data storage system 100 reconstructs a data beam carrying the information stored in the storage media 1-10, 1-11, 1-12 by directing the reference beam 110B into the storage location containing the hologram storing the desired data. This is again accomplished using the switches 1-4a, 1-4b, if present. The reconstructed data beam 130 emerges from the selected holographic storage medium 1-10, 1-11, or 1-12 traveling in the opposite direction of the reference beam 10B. The reconstructed data beam 130 travels eventually to beamsplitter 1-2, which transmits a portion of the beam to an image detector array (IDA) 1-9, or imager, which may be an OV9121 camera chip available from Omni Vision of Sunnyvale, Calif., or another suitable device. During the read cycle the beam 120 may be suppressed by using SLM 1-3 to attenuate the pixels as discussed earlier.

The recording media 1-10, 1-11, 1-12 can be any type of holographic recording media. Examples of organic and inorganic media types are: photopolymer, available from Aprilis of Marnard, Mass.; photorefractive crystal; photochromic material; and bacteriorhodopsin (BR) in gelatin or other hosts. These are examples only and the media type is not meant to be so limited. Different types of media allow the characteristics of the storage system 100 to be tuned to a specific application. As one example, a write-once media such as a photopolymer can be used for archival or legal document storage. The media 1-10, 1-11, 1-12 may also be removable allowing it to be used as a distribution medium for items such as music, videos, or books. In this manner, the media 1-10, 1-11, 1-12 may provide similar functionality as CD, CDR-W, DVD, DVD in both writeable and rewriteable formats.

In one embodiment, a switch 1-13 may be provided to control output of the laser 1-1. The switch 1-13 could be a liquid crystal light valve, which may use a liquid crystal rotator (as are, for example available from Meadowlark Optics of Fredrick, Colo.) and with a polarizer at the output (which are available, for example, from Moxtek, Inc. of Orem, Utah) and may control the amplitude and/or the duration of data and reference beams 120, 110B, respectively. Likewise, the SLM 1-3 can be used to block the power in the data beam 120 by setting the pixels to low or zero transmission. This may be particularly useful during read cycles.

Focusing optics may also be located within the paths of the various beams 105, 11A, 110B, 120. The focusing optics 1-14, 1-15, 1-16 could be, for example, a lens 1-14 inserted in the reconstructed data beam 130 path to focus an image onto the image detector array 1-9. This can significantly increase the number of pixels, which can be stored and retrieved by reducing the effect of the diffraction spreading of the spatial beam portion emanating from each pixel of the by the SLM 1-3. Additionally, a field lens 1-15 may be placed near the SLM 1-3 to direct more light into the storage media 1-10, 1-11, 1-12. As more storage locations are included in the design, the optical path length between the SLM 1-3 and the image detector array 1-9 and through storage locations further to the right of FIG. 1 increases. Additional focusing optics may be added as needed. This includes forming a lens using the input and/or input surfaces of the medium as shown at 1-16 in FIG. 1.

Additional data may be stored in a particular storage location 1-10, 1-11, 1-12 using wavelength multiplexing. This can be accomplished, for example, by thermally tuning the laser 1-1 to a frequency which does not substantially couple to any previously written patterns or holograms in the media 1-10, 1-11, 1-12.

Additional light sources such as light emitting diodes (LEDs) 1-17, 1-18, may also be used for erasing or pumping the media 1-10, 1-11, 1-12. Light from one of the LEDs 1-17, 1-18 can be injected into the optical path of the beam 105 using beamsplitters 1-19, or 1-20 as shown. These beamsplitters 1-19, 1-20 may be made wavelength selective by using dielectric layers so that they only substantially reflect the erase or pump wavelengths. Pumping is an exposure by light prior writing in order to improve storage. The added light can then be directed to a particular storage location for pumping or erasure using the optical switches 1-4a, 1-4b, 1-7a, 1-7b, and/or others if present.

A Faraday rotator 1-24, such as an LD-38-R-670 available from Electro-Optics Tech, in Traverse City, Mich., may be located as shown to rotate the polarization of any laser light reflected back into the laser. This frequently can be used improve laser stability.

FIG. 2 is a schematic illustration of arrangement or structure containing multiple optical switches for use in a holographic memory system. An optical switch in the arrangement or structure 200 utilizes polarization sensitive beamsplitters and liquid crystal (LC) elements. The LC, under the influence of an electric field signal, can cause the polarization of a transmitted light or beam to rotate by 90 degrees. The polarization sensitive beamsplitters will direct the transmitted beam in either of two directions dependent upon the polarization. FIG. 2 illustrates a binary tree structure containing several optical switch positions using this principle. Two of these structures, an upper and a lower as shown in FIG. 2, may be coupled to the optical components shown within the dashed rectangle 1-21 of FIG. 1, so that the upper beams 110B and 130 become the beam 2-10 of FIG. 2 and lower beam 120 of FIG. 1 becomes the beam 2-18 of FIG. 2. An incoming beam 2-10 enters the first LC 2-11, which sets the output to either one of two linear, orthogonal polarization states. Depending on the polarization, beamsplitter 2-1 will either transmit this beam on to reflector 2-2 or reflect it through LC 2-12 onto beamsplitter 2-16. FIG. 2 illustrates the beam 2-10 being transmitted on to reflector 2-2, which directs the beam through LC 2-12 and onto beamsplitter 2-3. LC 2-12 can be used to adjust the polarization of the beam 2-10, which strikes beamsplitter 2-3 to either one of two linear, orthogonal polarization states, as before. Depending on the polarization, beamsplitter 2-3 will either transmit the beam 2-10 through LC 2-13 and on to beamsplitter 2-17 or reflect it on to reflector 2-4. Like processes continue in order to eventually select a particular storage location such as 2-8 as illustrated in FIG. 2, which, for clarity, only depicts two others, locations 2-7 and 2-9. The storage locations 2-7, 2-8, and 2-9 may be substantially similar to storage locations 1-10, 1-11, 1-12 of FIG. 1. Only three storage locations 2-7, 2-8, 2-9 are shown here but it is understood that many may be present.

The polarization sensitive beamsplitters 2-1, 2-2, 2-3, 2-4, 2-5, 2-6 and others can be fabricated from subwavelength polarization sensitive gratings as are, for example available from Moxtek, Inc. of Orem, Utah. Suitable LCs are available from, for example, Meadowlark Optics of Fredrick, Colo. The spatial frequency of the lines of these gratings can be sufficiently high to suppress the first order diffracted beam. This enhancement reduces the maximum number of switches that the beams must pass through in order to be routed by arranging them into a tree like path. Though the FIG. 2 illustrates a binary arrangement, the trinary or higher order arrangements can be used. Other arrangements are contemplated including using full trees, partial trees cascaded trees and/or combinations thereof.

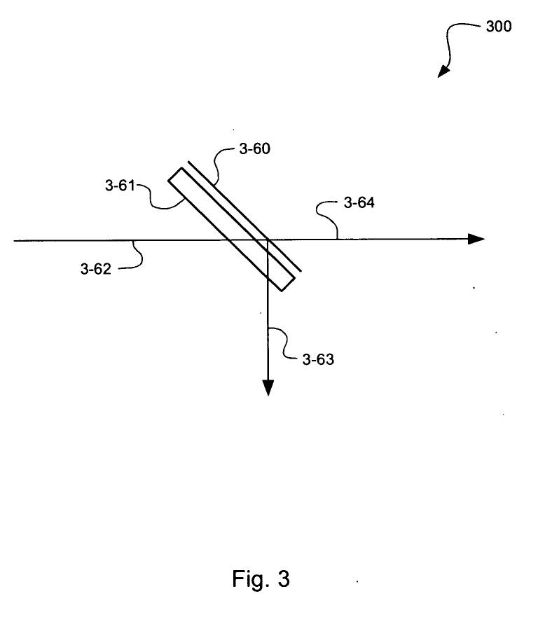

Referring now to FIG. 3, a schematic illustration of another embodiment of an optical switch for use in a holographic memory system is shown. Here, LC 3-61 is sufficiently close to the polarization sensitive beamsplitter 3-60 that the incoming beam 3-62 passing through it once then upon being reflected by polarization sensitive beamsplitter 3-60 then passes through LC 3-61 yet a second time. This causes both the reflected output beam 3-63 and the transmitted output beam 3-64 to have the same polarization when the LC is adjusted to cause a 0 degree rotation for transmission and a single pass 90 degree rotation for reflection. The polarization sensitive beamsplitter can be a fine line grating as mentioned earlier. Further, the efficiency of the grating can be varied by making the lines thinner or using an alloy with a lower conductivity so that even if the LC causes a full 90 degree rotation, some portion of the beam still transmits through the 3-60. This device is a switchable beamsplitter.ADD

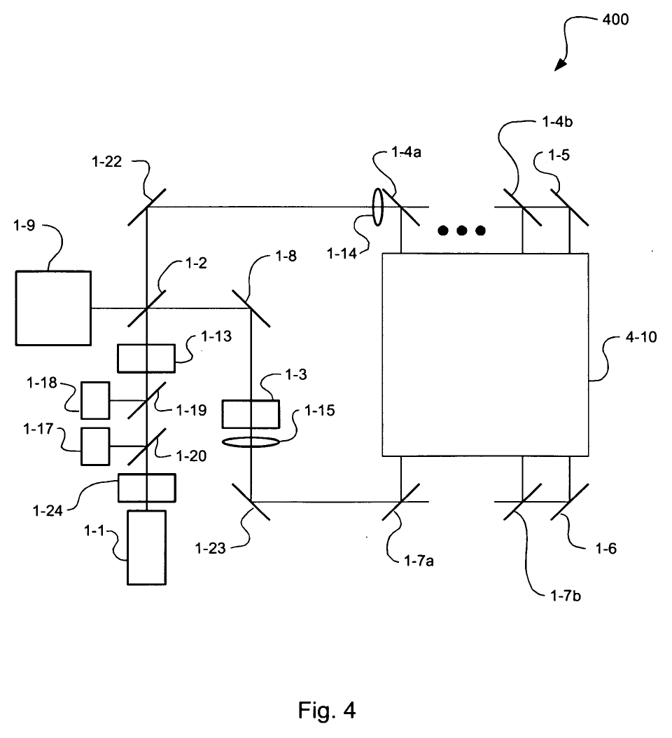

Referring now to FIG. 4, a schematic illustration of another embodiment of a holographic data storage system in accordance with principles of the present disclosure is shown. FIG. 4 illustrates another embodiment of the invention which utilizes a slab of media 4-10 instead of the linear array of rods. The number of optical switches 1-4a, 1-7a, etc can be chosen to use as much of the medium as desired. This offers the potential advantage of ease of manufacture. The medium 4-10 may be formed into a thin sheet, which may be flexible. The medium 4-10 as a sheet forms an optical waveguide. The thickness of the sheet may be chosen so that at least one vertically transverse mode is readily distinguishable from the others. In one embodiment, data to be recorded is impressed onto this mode which may then be recorded within medium 4-10 using the generally oppositely traveling writing reference beam as described with respect to FIG. 1. During the read cycle, the read beam is within a readily distinguishable vertically transverse mode, which is guided by internal reflection by the media surfaces. One vertically transverse mode can store one horizontal row of SLM 1-3 pixels. The data also may be impressed upon any additional modes, which are distinguishable. Additional, vertically transverse modes therefore could be used to store one or more additional SLM 1-3 horizontal rows or to redundantly store an additional copy of a row. Additional layers may be added on top of to form a sandwich containing two separate waveguides each of which may be used to store a row of SLM pixels.

The invention provides that the curvature of the media 4-10 may be limited and its surfaces may be formed smooth and maintained clean so that the coupling between modes may limited to levels which will not prevent the recovery of the data during the read cycle. As one example, if the media 4-10 film is made sufficiently thin, then only one symmetric TE mode propagates. This occurs when:
d<(wavelength/2)/delta
where delta is the square root of the quantity which is composed of the square of the index of the media 4-10 film minus the square of the index of the material surrounding the media 4-10 film. The medium 4-10 as a sheet could be a polymer with an index of refraction of 1.47 and be laminated between layers of polymer with an index of refraction of 1.468 to form a sandwich, then a thickness less than about 4.2 micrometers will provide only one propagating mode. Both the reference beam and the data beam may be launched into this mode from opposite sides of the sandwich. The outer surface of the sandwich may be made rough or index matched to an absorbing material so that light, which leaks out of the propagating mode, will be removed from the sandwich by either scattering or absorption.

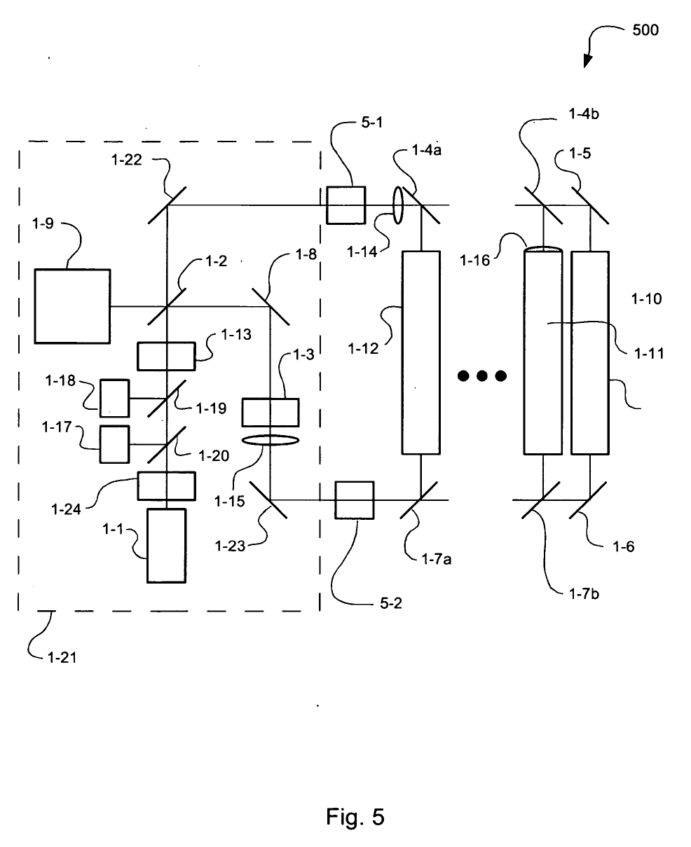

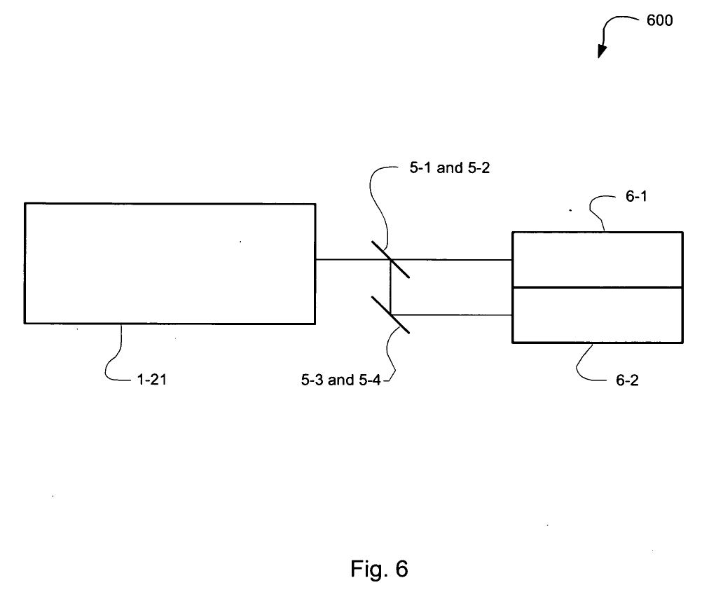

Referring now to FIG. 5 a schematic illustration of another embodiment of a holographic data storage system 500 in accordance with principles of the present disclosure is shown. In this embodiment the media rods 1-10, 1-11, 1-12 (or slabs) are stacked in layers. Only the top layer is visible in FIG. 5. Each layer may have its own set of optical switches, but they all may share the same optoelectronic components within the dashed rectangle 1-21, which are intended to function the same as those shown in the dashed rectangle 1-21 of FIG. 1 described earlier. Optical switches 5-1 and 5-2 and reflectors 5-3 and 5-4 (not shown in FIG. 5 but shown in FIG. 6 discussed below) perform the task of switching between media layers

FIG. 6 is a schematic side view where optical switches 5-1 and 5-2 and reflectors 5-3 and 5-4 are graphically superimposed and the two layers, now visible, are denoted as 6-1 and 6-2. Even though the example shown in FIG. 6 is just 2 layers or stories, this embodiment is scaleable to more than 2 stories using additional optical switches. The invention also provides the tree-structure described above may be used to address additional layers. This new embodiment of the invention multiplies the storage capacity of the originally described embodiment of the invention by the number of stacked layers (i.e. doubles the storage capacity in the example shown in FIG. 6) with little or no change in the system footprint.

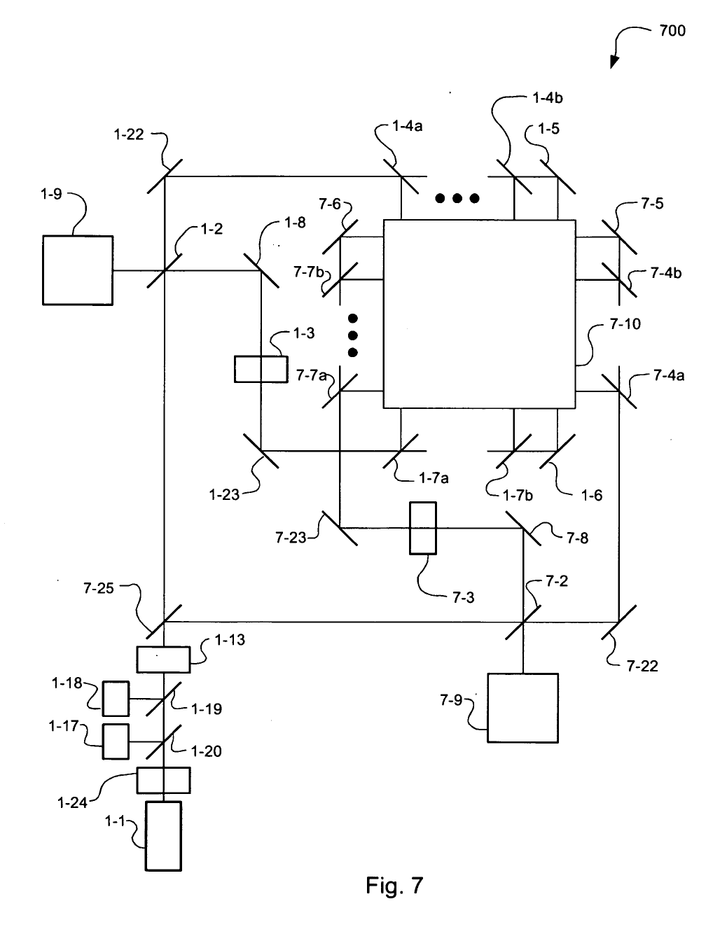

Referring now to FIG. 7 a schematic illustration of another embodiment of a holographic data storage system in accordance with principles of the present disclosure is shown. This is an embodiment which records into a square medium slab 7-10 using all four sides. One additional optical switch, such as optical switch 7-25 may be used to direct the laser beam and/or the pump or erase sources 1-17 and 1-18, if present, to either beamsplitter 1-2 or 7-2. The additional components: reflectors 7-8 and 7-23; SLM 7-3; optical switches 7-7a, 7-7b, 7-4a, and 7-4b; reflectors 7-6 and 7-5; reflector 7-22, and image detector array 7-9 may be substantially similar to those components whose functions have already been described. The embodiment of FIG. 7 potentially doubles the storage capacity of the previously described embodiments with only approximately a 75% increase in system volume. This embodiment may also have increased utilization of available dynamic range, as pages recorded in one direction will not appreciably increase the crosstalk between pages recorded in other directions. The crosstalk is therefore much less than if all the pages were recorded in one direction.

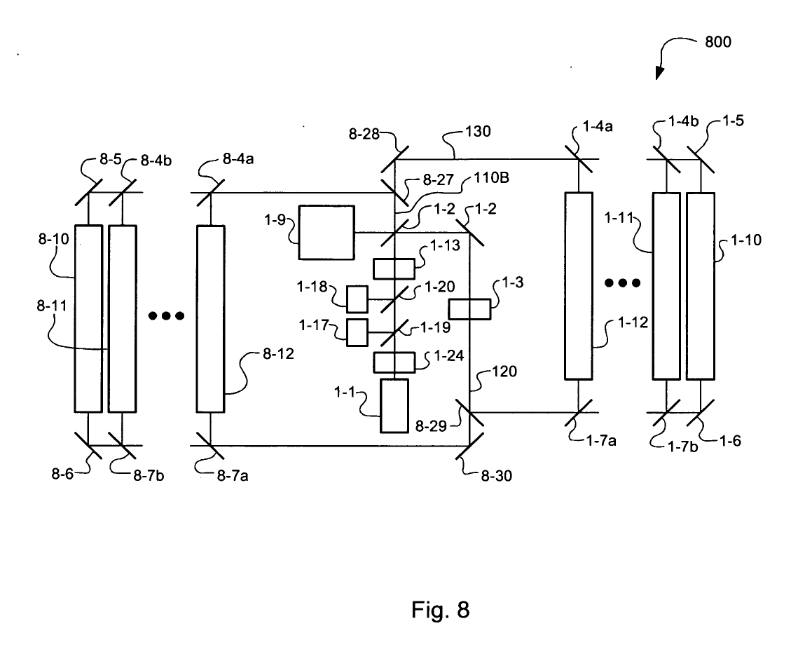

FIG. 8 is a schematic illustration of another embodiment of a holographic data storage system in accordance with principles of the present disclosure. FIG. 8 is an embodiment adapted from FIG. 1 to include additional media 8-10, 8-11, 8-12 and more if desired. Optical switch 8-29 is used to direct beam 120 either to optics 1 switches 1-7a, 1-7b, or reflector 1-6, or to allow it to transmit to reflector 8-30 an then to optical switches 8-7a, 8-7b or to reflector 8-6. Likewise, optical switch 8-27 can be used to reflect beam 10B to either the optical switches 8-4a, 8-4b or reflector 8-5 or to transmit beam 110B to reflector 8-28. Similarly with beam 130. This embodiment can be used to include an additional slab medium to the embodiment of FIG. 4 as well. This embodiment records into two sets of rods (or slabs) sharing just one laser, SLM, and Imager.

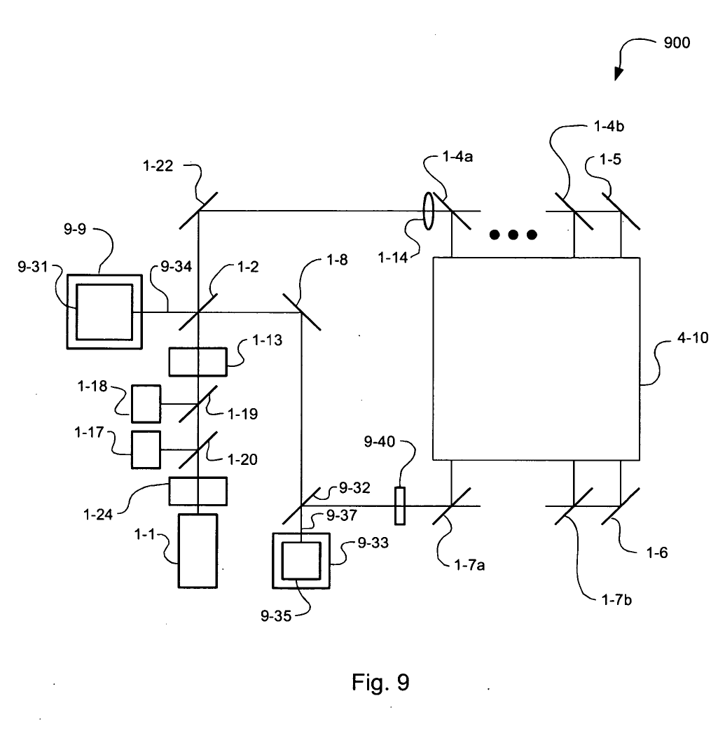

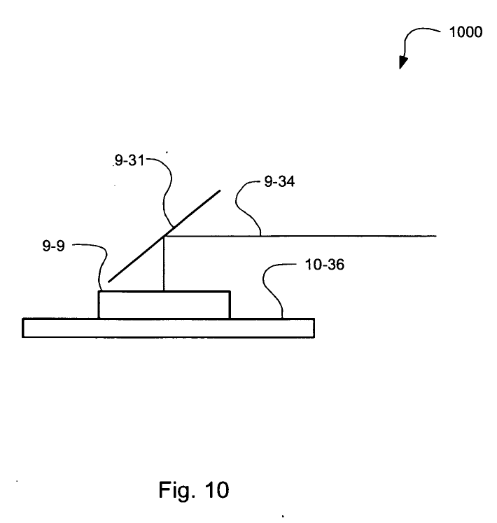

Referring now to FIG. 9, a schematic illustration of another embodiment of a holographic data storage system in accordance with principles of the present disclosure is shown. This embodiment allows the SLM and Imager to be tipped over 90-degrees to the main optical axis of the system. The return beam containing the data during the read cycle is denoted 9-34. Beam 9-34 strikes reflector 9-31 which directs it onto image detector array 9-9. This is more easily seen in the schematic side view in FIG. 10. This feature is particularly useful to accommodate an electronic circuit board 10-36.

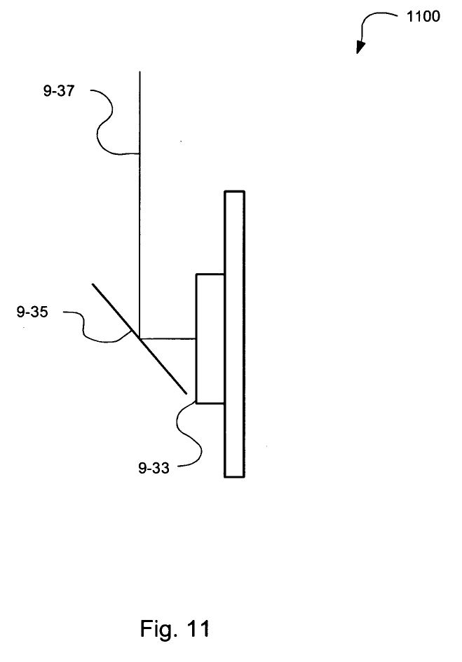

Referring back to FIG. 9, reflector 9-35 directs beam 9-37 onto the reflective type SLM 9-33, which could be a BR1080HC, available from Brillian Corp. of Tempe, Ariz., or an SXGA-R2D-H1 from CRL Opto Ltd. of Dunfermline, Scottland. Beamsplitter 9-32 is preferably a polarization sensitive beamsplitter, such as a sub wavelength grating available from Moxtek, Inc. of Orem, Utah. This beamsplitter is oriented to pass that portion of beam 9-37 arriving from the laser via reflector 1-8 and beamsplitter 1-2. The SLM 9-33 changes the polarization of spatial portions or pixels within the original beam 9-37. Those portions or pixels whose polarization is unchanged by SLM 9-37 will, upon emerging from the SLM, reflect off 9-35 and pass through polarization beamsplitter 9-32 and heading back toward reflector 1-8. Beamsplitter 9-32 will, however, reflect the portion of the electric field of those pixels whose polarization is changed by SLM 9-37 on to half waveplate 9-40, which is oriented to rotate the polarization back to the original state. From here the beam passes on to the selected storage location where it will interfere with the reference beam and produce a hologram. FIG. 11 is a schematic side view of the tipped SLM 9-33, reflector 9-35, and beam 9-37.

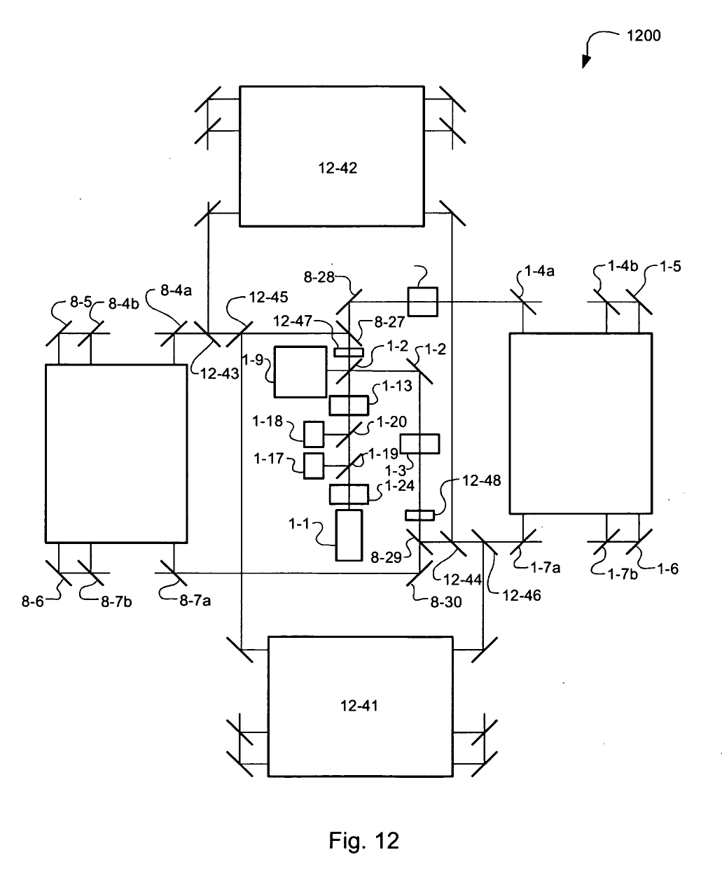

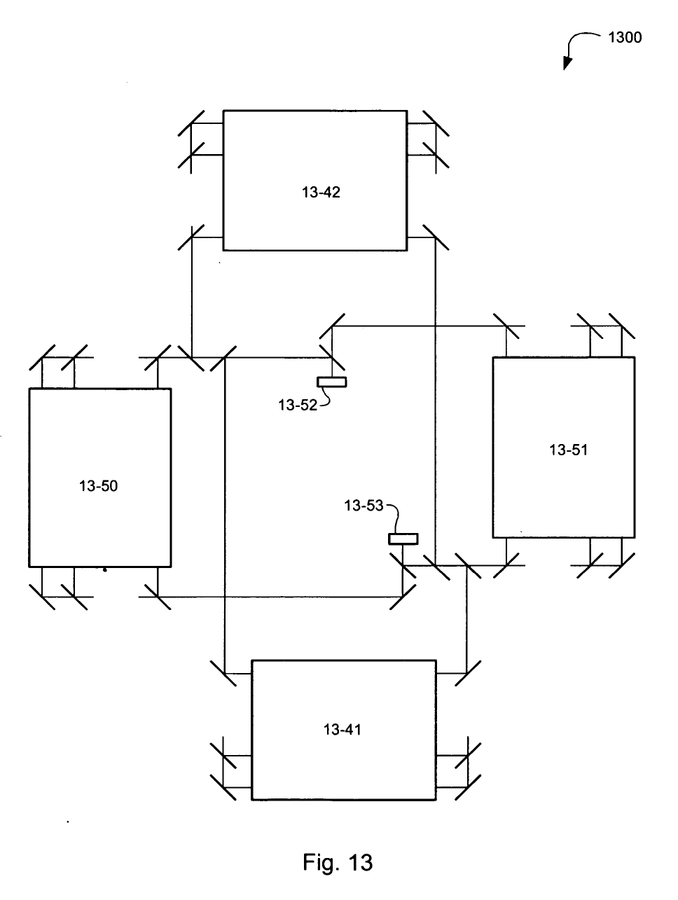

Referring now to FIG. 12, a schematic illustration of another embodiment of a holographic data storage system in accordance with principles of the present disclosure is shown. FIG. 12 is an adaptation of FIG. 8 and includes one or more additional media assemblies each of which comprise a slab medium, optical switches and reflectors as described in greater detail earlier. Optical switches 12-43 and 12-44 steer beams to and from assembly 12-42. Optical switches 12-45 and 12-46 steer beams to and from assembly 12-41. The media may also be arrays of rods. This embodiment provides that lenses may be added within the beam paths to effect focusing and/or control divergence. This embodiment also provides that optical switches 12-47 and 12-48 may be placed into the beam paths to direct the beams to additional media layers as discussed earlier with reference to FIG. 5. These additional media layers could be as pictured in FIG. 13 and include media 13-41, 13-42, 13-50, and 13-51. 13-52 and 13-53 may be optical switches to either intercept the beams or to permit it to pass on to additional layers. If there are no additional layers then 13-52 and 13-53 may be simple reflectors. This embodiment further increases storage without adding additional lasers, SLMs, or detectors.

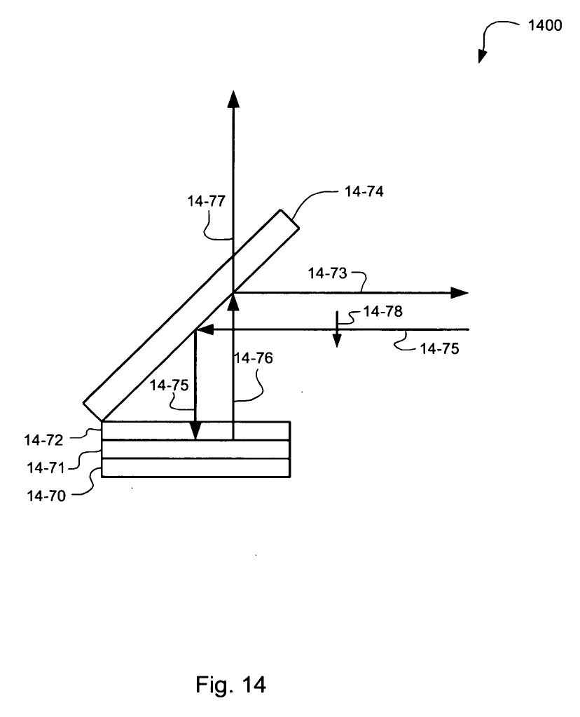

FIG. 14 is a schematic illustration of a combined spatial light modulator (SLM) and imager. A polarization sensitive beamsplitter 14-74 reflects a particular polarization component, designated generally by 14-78, of incoming beam 14-75. The beam proceeds down through SLM 14-72 which adjusts the polarization at the various pixel locations in a manner corresponding to the data to be stored. A portion of the light from each pixel will be reflected by polarization beamsplitter 14-71 as determined by its adjusted polarization. These reflected portions travel back as depicted by arrow 14-76, which is shown displaced to the right for clarity, and proceed through SLM 14-72 having their polarizations adjusted yet a second time. From here they travel back to beamsplitter 14-74 which reflects a portion of each pixel again in accordance with its adjusted polarization. Aside from absorption, the remainder of the light in each pixel travels through beamsplitter 14-74.

As one example of the operation of this device, assume an SLM pixel is adjusted to be a ½ waveplate and oriented so that it rotates the polarization of a spatial portion of light from beam 14-75 by 90 degrees. this light strikes beamsplitter 14-71, which is oriented to reflect it back through the SLM, which again rotates its polarization by 90 degrees so that it is again reflected by beamsplitter 14-74 as depicted by beam 14-73. If, however, an SLM pixel is adjusted to be a zero waveplate, i.e. causes no differential retardance, then light from beam 14-75 upon passing through the SLM would not be rotated and therefore would pass through beamsplitter 14-71 and onto image detector array 14-70 and would be generally absorbed. Thus, data can be impressed upon beam 14-73 during a write cycle. During a read cycle, beam 14-75 would be the reconstructed data beam. Setting all of the SLM pixels to zero retardance would generally allow the beam to strike the image detector array and be absorbed and converted to an electrical signal. This integrated SLM/Imager reduces the number of optoelectronic components and thereby the optoelectronic overhead MIGHT SIMPLIFY REGISTRATION OF slm AND IMAGER PIXEL.

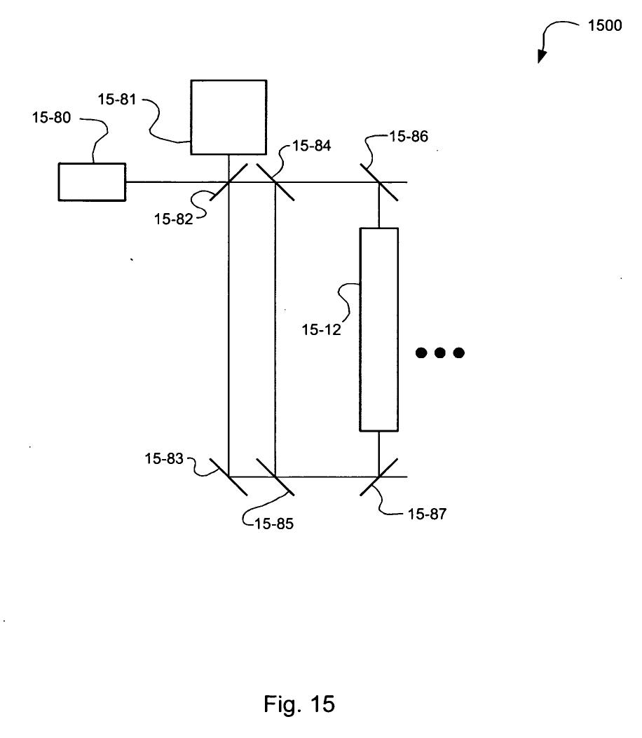

FIG. 15 illustrates another record and read geometry, which is termed conjugate. During a write cycle, light from laser 15-80 encounters a switchable beamsplitter 15-82 as illustrated in FIG. 3. The switchable beamsplitter 15-82 transmits a portion, termed the reference beam through optical switch 15-84 and on to optical switches, like 15-86, which direct the light to a storage location as described earlier. The portion of the beam reflected by switchable beamsplitter 15-82 travels to the SLM/imager 15-81, which reflects a portion, termed the data beam, upon which has been impressed the data to be stored, as described above with reference to FIG. 14. A portion of the data beam travels through the switchable beamsplitter 15-82, on to reflector 15-83, then through optical switch 15-85, and on to optical switches, like 15-87, which direct the light to a storage location, also as described earlier. The reference and the data beam interfere within storage location 15-12 producing a hologram.

During the read cycle, the beam from laser 15-80 again encounters switchable beamsplitter 15-82, which is now adjusted to transmit all of the beam on to optical switch 15-84, which is adjusted to reflect it to optical switch 15-85, which is adjusted to reflect it on to optical switches, like 15-87, which direct the light to a storage location also as described earlier. The medium in the selected storage location reconstructs a backward traveling data beam which essentially follows the same path back to the SLM/imager 15-81.

It will be appreciated by those skilled in the art having the benefit of this disclosure that this invention provides a holographic data storage system. The data storage system includes a holographic data storage media adapted to receive a data beam and a reference beam and store a data pattern associated with the data beam. The data pattern is expressed by a holographic representation corresponding to data elements of the data beam. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. A holographic data storage system comprising:
means for generating a reference beam;
means for generating a data beam containing a spatially modulated amplitude representing data elements; and
a holographic data storage media adapted to receive the data beam and reference beam and store a data pattern associated with the data beam, the stored data pattern being expressed by a holographic representation corresponding to the data elements of the data beam.

2. The holographic data storage system of claim 1, further comprising:
a plurality of discrete data storage cells within the holographic storage media, each adapted to receive at least a portion of the data beam and at least a portion of the reference beam and store a data pattern associated with the data beam; and
a plurality of switches adapted to selectively reflect at least a portion of the data beam to one of the plurality of discrete data storage cells.

3. The holographic data storage system of claim 1, further comprising an image detector array adapted to retrieve data elements from a reconstructed data beam from the holographic data storage media, the reconstructed data beam being generated in response to a reference beam provided to the holographic data storage media following a data storage in the holographic data storage media.

4. The holographic data storage system of claim 1, wherein the means for generating a data beam containing a spatially modulated amplitude representing data elements comprises a spatial light modulator.

5. The holographic data storage system of claim 1 further comprising at least one optic lenses adapted to focusing the data beam.

6. The holographic data storage system of claim 1 wherein the holographic data storage media comprises a photopolymer

7. The holographic data storage system of claim 1 wherein the holographic data storage media comprises an array of holographic data storage elements, each element being accessible by the data beam and reference beam through a plurality of solid state optic switches.

8. The holographic data storage system of claim 1 wherein the holographic data storage media comprises a holographic film.

9. The holographic data storage system of claim 1 wherein the means for generating a reference beam and means for generating a data beam comprises a laser.

10. The holographic data storage system of claim 9, further comprising a light emitting diode (LED) adapted for selectively pumping the laser.

11. A holographic data storage system comprising:
a first laser adapted to generate a reference beam;
a second laser adapted to generate a data beam containing a spatially modulated amplitude representing data elements; and
a plurality of discrete data storage cells each containing a holographic data storage media adapted to receive at least a portion of the data beam and at least a portion of reference beam and store a data pattern associated with the data beam, the stored data pattern being expressed by a holographic representation corresponding to the data elements of the data beam.

12. The holographic data storage system of claim 11, further comprising a plurality of switches adapted to selectively reflect at least a portion of the data beam to at least one of the plurality of discrete data storage cells.

13. The holographic data storage system of claim 11, further comprising an image detector array adapted to retrieve data elements from a reconstructed data beam from at least once of the discrete data storage cells, the reconstructed data beam being generated in response to the reference beam being provided to the at least once data storage cell following a data storage in the at least one data storage cell.

14. The holographic data storage system of claim 11, wherein the second laser further comprises a spatial light modulator adapted to modulate the data beam to contain a spatially modulated amplitude representing data elements.

15. The holographic data storage system of claim 11, further comprising at least one optic lenses adapted for focusing the data beam.

16. The holographic data storage system of claim 11, wherein the holographic data storage media comprises a photopolymer.

17. The holographic data storage system of claim 11, wherein the holographic data storage media comprises a holographic film.

18. The holographic data storage system of claim 11, further comprising a light emitting diode (LED) adapted for selectively pumping the first laser.

19. A holographic data storage system comprising:
a first laser adapted to generate a reference beam, the first laser being selectively pumpable;
a second laser with a special light modulator and adapted to generate a data beam containing a spatially modulated amplitude representing data elements;
a plurality of discrete data storage cells each containing a holographic data storage media;
a plurality of switches adapted to selectively reflect at least a portion of the data beam in to at the plurality of discrete data storage cells;
wherein the plurality of discrete data storage cells is each adapted to receive at least a portion of the data beam and at least a portion of reference beam and store a data pattern associated with the data beam, the stored data pattern being expressed by a holographic representation corresponding to the data elements of the data beam.

20. The holographic data storage system of claim 19, further comprising and image detector array adapted to retrieve the data elements from a reconstructed data beam from the holographic data storage media.
